(19) United States
(12) Patent Application Publication
(10) Pub. No.: US 2025/0384789 A1
(43) Pub. Date: Dec. 18, 2025

(54) ULTRASOUND-GUIDED PROCEDURE INSERTS FOR PATIENT SIMULATORS

(71) Applicant: GAUMARD SCIENTIFIC COMPANY, INC., Miami, FL (US)

(72) Inventors: Luis MARZO, Miami, FL (US); Siobhain LOWE, Miami, FL (US)

(21) Appl. No.: 19/241,976

(22) Filed: Jun. 18, 2025

Related U.S. Application Data
(60) Provisional application No. 63/661,494, filed on Jun. 18, 2024.
(60) Provisional application No. 63/661,498, filed on Jun. 18, 2024.
(60) Provisional application No. 63/661,500, filed on Jun. 18, 2024.
(60) Provisional application No. 63/661,505, filed on Jun. 18, 2024.

(51) Int. Cl. G09B 23/28; G09B 23/30

(52) U.S. Cl. CPC G09B 23/286; G09B 23/303

(57) ABSTRACT

Ultrasound-guided procedure inserts for patient simulators, as well as associated devices, systems, and methods, are provided. An ultrasound-guided procedure insert for a patient simulator, the insert comprising: a simulated skin layer; a body coupled to the simulated skin layer; and at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system.

### CROSS-REFERENCE TO RELATED APPLICATIONS

The present application claims priority to and the benefit of U.S. Provisional Patent Application No. 63/661,494, filed Jun. 18, 2024, U.S. Provisional Patent Application No. 63/661,498, filed Jun. 18, 2024, U.S. Provisional Patent Application No. 63/661,500, filed Jun. 18, 2024, and U.S. Provisional Patent Application No. 63/661,505, filed Jun. 18, 2024, each herein incorporated by reference in its entirety.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. Nos. 11,756,451, 8,696,362, 8,016,598, 7,976,312, 7,976,313, U.S. patent application Ser. No. 11/952,669 (Publication No. 20090148822), U.S. Pat. Nos. 7,114,954, 6,758,676, 6,503,087, 6,527,558, 6,443,735, 6,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure pertains to the field of medical simulation technology, specifically within the area of healthcare education and clinical skills training devices. Aspects address the need for realistic, interactive, and safe training environments for medical personnel to practice invasive procedures, particularly those guided by ultrasound imaging. Traditional training methods, such as textbooks and static models, lack the tactile and visual realism necessary for effective skill acquisition, while direct practice on live patients poses unacceptable risks. Existing patient simulators, though beneficial, have not fully replicated the complexity and fidelity required for advanced procedural training, especially for ultrasound-guided interventions.

To overcome these limitations, the present disclosure provides advanced patient simulators equipped with modular, ultrasound-guided procedure inserts. The inserts feature anatomically accurate simulated skin layers, underlying body structures, and at least one simulated vessel (vein, artery, or both), which can be connected to a system that controls the flow of simulated blood. The vessels are specifically designed to be imaged using commercially available ultrasound systems, enabling realistic visualization, differentiation, and/or manipulation under ultrasound guidance. In some aspects, features such as palpable arterial pulses, compressible veins, bifurcations, and the inclusion of additional anatomical structures (e.g., clavicle, intestines, bladder) to simulate various access sites (femoral, subclavian, paracentesis, etc.) are provided. Integrated control systems allow for real-time adjustment and/or monitoring of vital parameters such as heart rate, blood pressure, and/or blood flow, while the modular design supports repeated use and rapid replacement of inserts.

This disclosure describes ultrasound-guided procedure inserts for patient simulators. In some aspects, an ultrasound-guided procedure insert comprises: An ultrasound-guided procedure insert for a patient simulator, the insert comprising: a simulated skin layer; a body coupled to the simulated skin layer; and at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system. The at least one simulated vessel may comprise a simulated vein, a simulated artery, or a simulated vein and a simulated artery. The at least one simulated vessel may further comprise a bifurcation.

The simulated skin layer, the body, and the at least one simulated vessel may be sized and shaped to simulate a femoral access site.

The simulated skin layer, the body, and the at least one simulated vessel may be sized and shaped to simulate a subclavian access site. The insert may further comprise a simulated clavicle positioned at least partially within the body.

The simulated skin layer, the body, and the at least one simulated vessel may be sized and shaped to simulate a paracentesis access site. The insert may further comprise a simulated large intestine coupled to the body; and a simulated small intestine coupled to the body. The at least one simulated vessel may include an abdominal aorta and an inferior vena cava. The abdominal aorta may include a bifurcation. The inferior vena cava may include a bifurcation. The insert may further comprise a simulated bladder coupled to the body.

In some aspects, a patient simulator, comprises: a simulated body portion, the simulated body portion including an ultrasound-guided procedure site, the ultrasound-guided procedure site comprising: a simulated skin layer; a body coupled to the simulated skin layer; and at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective front view of a patient simulator including a simulated torso, a simulated head, a simulated neck, a simulated right arm, a simulated left arm, a simulated right leg, and a simulated left leg, including at least one insert using an insert connection system according to one or more aspects of the present disclosure.

FIG. 2 is a perspective front view of a patient simulator showing various inserts, according to one or more aspects of the present disclosure.

FIG. 3 is a perspective side view of a portion of a patient simulator showing various inserts and a display controller, according to one or more aspects of the present disclosure.

FIG. 4 is a screen display of a graphical user interface of a display controller, according to one or more aspects of the present disclosure.

FIG. 5 is a schematic view of a venous and arterial flow system of a patient simulator, according to one or more aspects of the present disclosure.

FIG. 6 is a schematic view of an invasive blood pressure system of a patient simulator, according to one or more aspects of the present disclosure.

FIG. 7 is an exploded view of a transmitter of an invasive blood pressure system of a patient simulator, according to one or more aspects of the present disclosure.

FIG. 8 is an end view of plates of the transmitter of FIG. 7, according to one or more aspects of the present disclosure.

FIG. 9 is a perspective view of a right arm of a patient simulator, according to one or more aspects of the present disclosure.

FIG. 10 is an exploded view of a right arm of a patient simulator, according to one or more aspects of the present disclosure.

FIG. 11 is a perspective view of an invasive blood pressure insert of a patient simulator, according to one or more aspects of the present disclosure.

FIG. 12 is a perspective view of an arm insert of a patient simulator, according to one or more aspects of the present disclosure.

FIG. 13 is a perspective view of a left arm of a patient simulator, according to one or more aspects of the present disclosure.

FIG. 14 is a perspective view of femoral inserts of a patient simulator, according to one or more aspects of the present disclosure.

FIG. 15 is an ultrasound image of a femoral insert of a patient simulator, according to one or more aspects of the present disclosure.

FIG. 16 is an ultrasound image showing a guidewire and a needle in use with a femoral insert of a patient simulator, according to one or more aspects of the present disclosure.

FIG. 17 is an ultrasound image showing a guidewire in use with a femoral insert of a patient simulator, according to one or more aspects of the present disclosure.

FIG. 18 is a partially exploded view of a subclavian insert of a patient simulator, according to one or more aspects of the present disclosure.

FIG. 19 is a front view of a paracentesis insert of a patient simulator, according to one or more aspects of the present disclosure.

FIG. 20 is an exploded view of the paracentesis insert of FIG. 19, according to one or more aspects of the present disclosure.

FIG. 21 is a front view of a pneumothorax insert of a patient simulator, according to one or more aspects of the present disclosure.

FIG. 22 is a perspective view of the pneumothorax insert of FIG. 21, according to one or more aspects of the present disclosure.

FIG. 23 is a perspective cross-sectional view of the pneumothorax insert of FIGS. 21-22, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulators disclosed herein offer a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulators allow for multiple users to simultaneously work with the patient simulator during a particular medical scenario, thereby facilitating team training and assessment in a realistic, team-based environment.

In several aspects, the patient simulators include features designed to enhance the educational experience. For example, in several aspects, the system includes a processing module and/or controller to simulate different medical and/or surgical scenarios during operation of the patient simulators. In some aspects, the medical and/or surgical scenarios include critical care procedure training, including without limitation IV placement, ultrasound-guided procedures (e.g., subclavian and/or IJ access, femoral access, paracentesis), pneumothorax procedures including tension pneumothorax procedures, arterial and/or venous access (e.g., right and left arms), etc. In several aspects, the system includes a camera system that allows visualization of the procedure for real-time video and log capture for debriefing purposes. In several aspects, the patient simulators are provided with a library of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard medical equipment and/or surgical instruments in a simulated patient treatment situation.

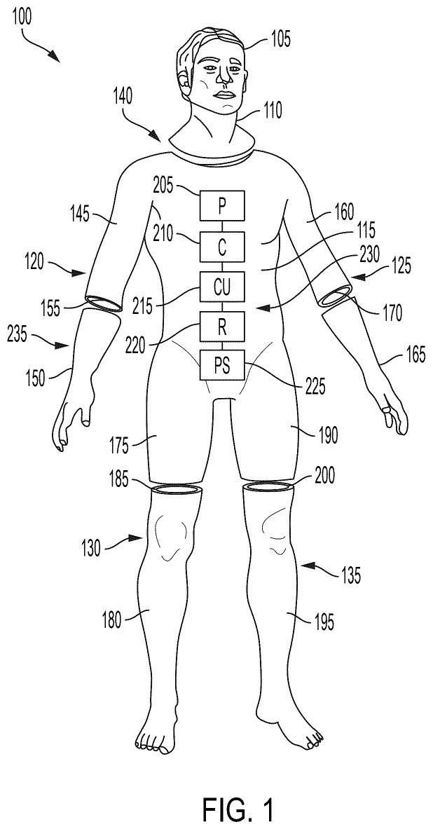

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170. In some aspects, the patient simulator 100 includes articulating joints in the shoulder, elbow, and/or wrist of the left and/or right arms 120, 125. For example, in some instances the left and/or right arms 120, 125 may be lifted and rotated such that the associated hand lies behind the head 105. In some instances, the left and/or right arms 120, 125 may be lifted straight outwards to ninety degrees relative to the torso 115. Further, in some instances, the lower left and/or right arms 150, 165 may be rotated to allow dorsal and palmer venous access. In some aspects, the wrist(s) of the lower left and/or right arms 150, 165 can bend, which may allow access for invasive blood pressure monitoring, IV placement, venipuncture training, or otherwise.

The simulated right leg 130 may include a simulated upper right leg 175 (or “extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas.

The control unit(s) 215 may be adapted to control the pump(s) 205, the compressor(s) 210, the reservoir(s) 220, including one or more valves associated with the pump(s), compressor(s), and/or reservoir(s), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO₂, etc.). The reservoir(s) 220 may include a single compartment or multiple compartments. The reservoir(s) 220 may be associated with one or more valves to control the flow of fluid and/or gas into and/or out of the reservoir(s) 220.

The power source(s) 225 may supply electrical power to the pump(s) 205, the compressor(s) 210, the control unit(s) 215, the reservoir(s) 220, including one or more valves associated with the pump(s), compressor(s), and/or reservoir(s), and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. The features/components to which electrical power is supplied by the power source(s) 225 may be contained in a different portion of the patient simulator 100 than the power source(s) 225. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), and various other features/components). In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components).

The patient simulator 100 may also include a venous and arterial flow system 230 and/or an invasive blood pressure system 235. The venous and arterial flow system 230 and/or the invasive blood pressure system 235 may utilize one or more of the pump(s) 205, the compressor(s) 210, the control unit(s) 215, the reservoir(s) 220, the power source(s) 225, and/or the other components of the patient simulator 100 to provide the associated functionality. In this regard, additional details of the venous and arterial flow system 230 and the invasive blood pressure system 235—as well as associated inserts—will be described further below.

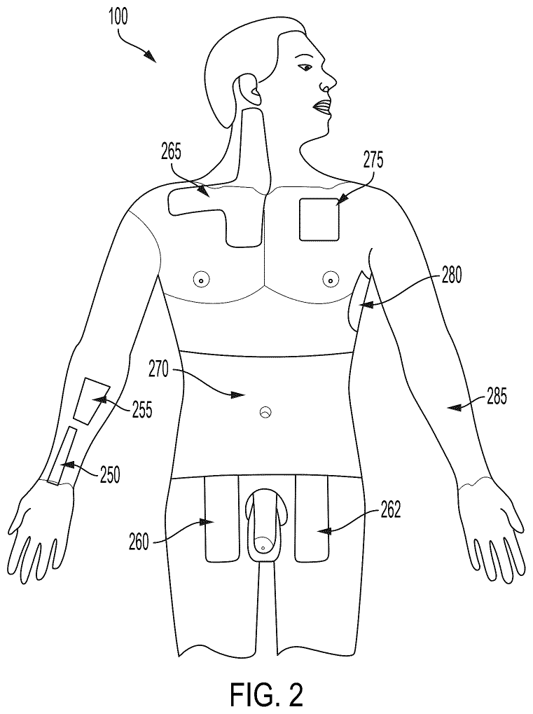

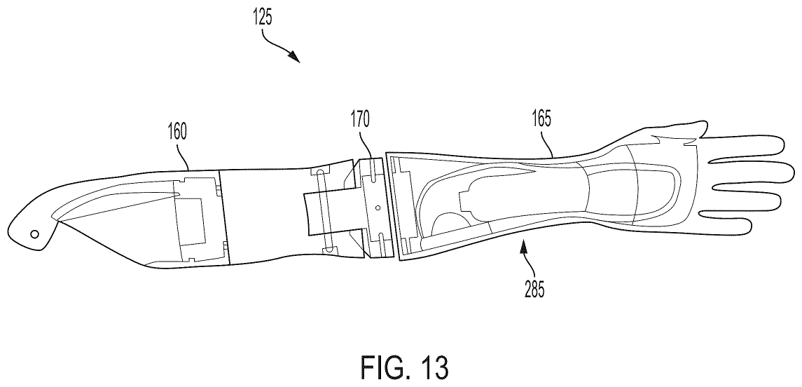

Referring to FIG. 2 and continuing reference to FIG. 1, the patient simulator 100 includes various inserts. In this regard, FIG. 2 is a perspective front view of the patient simulator 100 showing various inserts, according to one or more aspects of the present disclosure, including an invasive blood pressure insert 250, an arm insert 255, a right femoral insert 260, a left femoral insert 262, a subclavian insert 265, a paracentesis insert 270, a pneumothorax insert 275, and a thoracostomy insert 280. The patient simulator 100 may also include an IV training system 285 (see, e.g., FIG. 13 and the associated description). In some aspects, the patient simulator 100 may include one or more blank or functionless inserts to replace each of the various inserts shown. The blank inserts may be utilized to maintain aesthetics (e.g., avoiding a large opening in the skin) when a functional insert is not being used. In this regard, the blank inserts may be sized and shaped in a similar manner to the corresponding functional insert and include a skin layer to align with the surrounding portions of the patient simulator 100.

The patient simulator 100 may include one or more inserts for training of ultrasound-guided procedures. In some aspects, the subclavian insert 265, a femoral insert (e.g., right femoral insert 260 or left femoral insert 262), bilateral femoral inserts (e.g., right and left femoral inserts 260, 262), and/or the paracentesis insert 270 may each be configured for simulating ultrasound-guided procedures, including central line access (e.g., subclavian inserts, femoral inserts, etc.) and/or fluid removal (e.g., paracentesis insert, etc.). In this regard, the artery and vein are easily distinguished through palpation and/or ultrasound in both the subclavian insert 265 as well as the femoral inserts 260, 262. Arterial pulses are also palpable at these sites. The vein can be seen as clearly compressible and the artery pulsing under ultrasound evaluation. Needle and guidewire placement is visible under ultrasound with the ultrasound compatible inserts and the different tissue types can be identified. Similarly, once the cavity of the paracentesis insert 270 is filled with fluid, the organs and tissue types can be visualized under ultrasound and needle and/or catheter/guidewire insertion can be visualized in order to ensure vital organs are avoided during the simulated procedure. Additional details of the ultrasound compatible inserts will be described further below.

The thoracostomy insert 280 may include a multi-layer insert located on left side of the torso 115. The thoracostomy insert 280 may include a skin layer, a subcutaneous layer, ribs, fascia, a pleural membrane, and a pleural space. The pleural space of the thoracostomy insert 280 can be filled with air, simulated blood, or any fluid of choice. The thoracostomy insert 280 provides superior realism for cut down, blunt dissection, and/or insertion of a chest tube. The thoracostomy insert 280 may be used to simulate a pneumothorax, a hemothorax, and/or a thoracentesis.

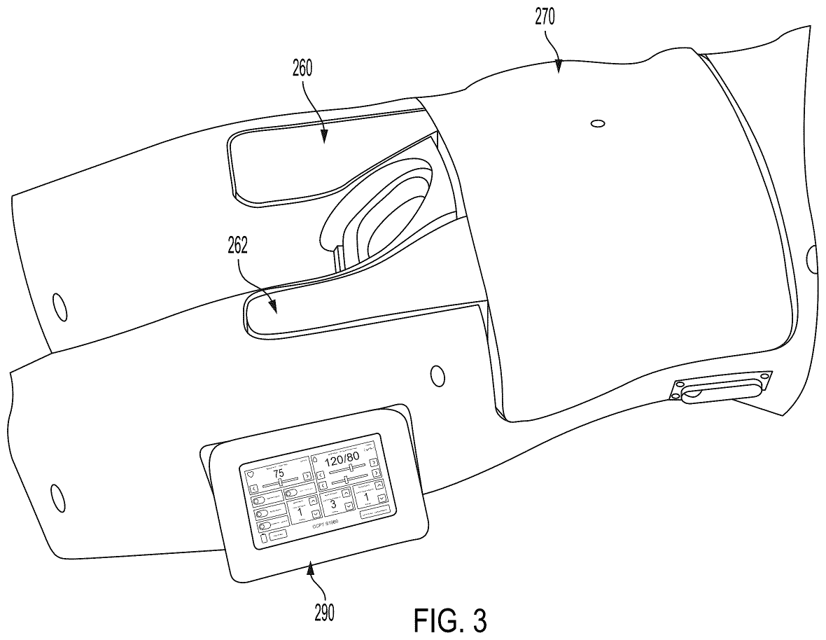

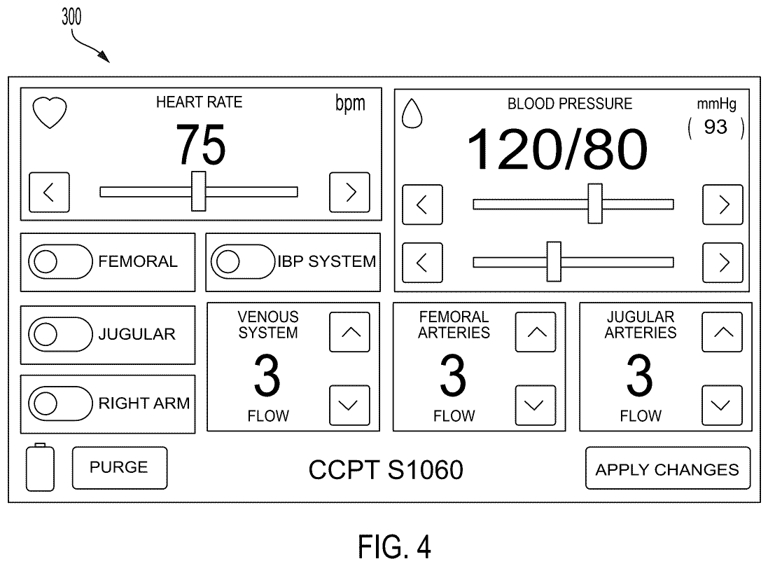

Referring now to FIGS. 3 and 4, with continuing reference to FIGS. 1-2, the patient simulator 100 includes a display controller 290. In this regard, FIG. 3 is a perspective side view of a portion of the patient simulator 100 showing various inserts, including the femoral inserts 260, 262 and the paracentesis insert 270, and the display controller 290, according to one or more aspects of the present disclosure. FIG. 4 is a screen display 300 of a graphical user interface of the display controller 290, according to one or more aspects of the present disclosure. As shown, the screen display 300 may include controls for adjustable heart rate (e.g., 30-200 beats per minute), blood pressure (e.g., 30-200 mmHg), blood flow rate (e.g., 1-5), and/or pulse strength (e.g., 1-5). The display controller 290 is an interface for controlling and monitoring vital parameters during simulated medical procedures. As shown, in some aspects the display controller 290 may be coupled to the left leg and/or hip of the patient simulator 100. The display controller 290 may be pivotably coupled to the patient simulator 100 to allow adjustment of the angle of the screen of the display controller 290 for better viewing. In some aspects, the display controller 290 may be separable from the patient simulator 100 and operate in a wireless communication mode with the various components and/or systems of the patient simulator 100.

The display controller 290 provides a user-friendly touchscreen control panel. The touchscreen control panel may utilize either capacitive or resistive touchscreens. Users interact with the touchscreen of the display controller 290 to control the patient simulator 100. The display controller 290 displays simulator battery level and provides an intuitive interface for adjusting settings. In this regard, the display controller 290 allows users to start and stop air-purging procedures (e.g., for the venous and arterial flow system 230 and/or the invasive blood pressure system 235), enable/disable one or more system functionalities/sections (e.g., femoral, jugular, right arm, and/or invasive blood pressure system 235), adjust one or more parameters such as heart rate, blood pressure, and/or intensity levels of the pulse and vein flow rate, and/or enable, select, or adjust other operating parameters and/or functionalities of the patient simulator 100.

As shown in FIG. 4, the display controller 290 includes a graphical user interface that provides various settings, controls, and/or information to the user. In the illustrated example, the user may select the heart rate in beats per minute (e.g., 30-200 beats per minute) using a slider and/or associated arrows or other suitable user interface. The user may select blood pressure using a slider and/or associated arrows or other suitable user interface. As shown, the diastole and systole blood pressure values may be separately selected. The user may activate and/or select flow rates for one or more venous or arterial systems. The user may activate the venous or arterial systems using a toggle button, on/off button, or other suitable user interface. The user may select the flow rate for the venous or arterial systems using up and down arrows, a slider, or other suitable user interface. In the illustrated example, a venous system flow, femoral arteries flow, and jugular arteries flow are shown with associated controls for activating/deactivating each of the systems and selecting the associated flow rate. The screen display 300 also includes a battery level indicator for the patient simulator 100. The screen display 300 also includes a purge button. In some aspects, the purge button can cause the venous and arterial flow system 230 to purge any air from the venous and/or arterial lines. In this regard, in some instances activating the purge button can trigger a purge pump of the venous and arterial flow system 230 that removes air from the venous and arterial lines of the system.

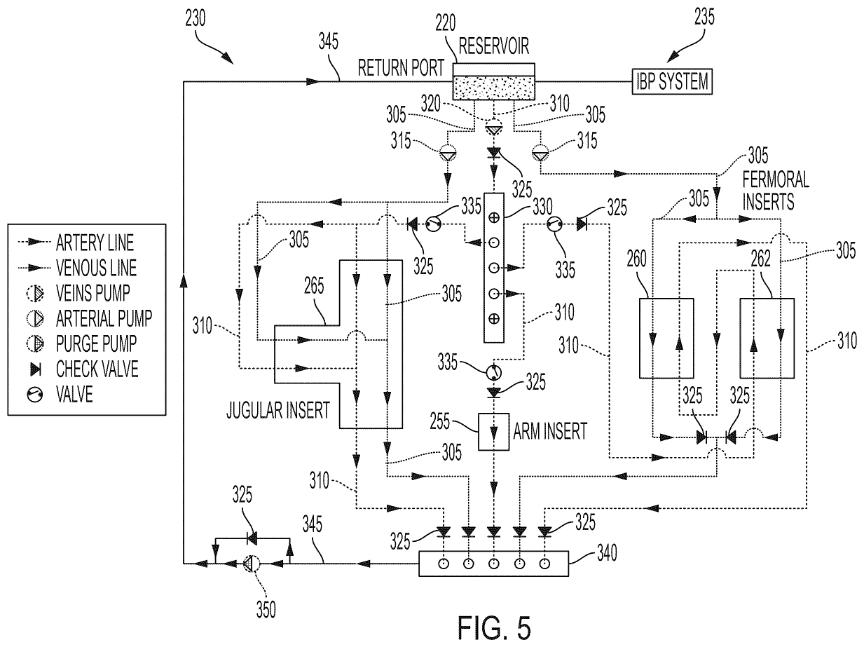

Referring now to FIG. 5, with continuing reference to FIGS. 1-4, the patient simulator 100 includes a venous and arterial flow system 230. In this regard, FIG. 5 is a schematic view of the venous and arterial flow system 230 of the patient simulator 100, according to one or more aspects of the present disclosure. The venous and arterial flow system 230 is designed to accurately replicate the blood flow in veins and arteries of the patient simulator 100, including the veins and arteries of the various inserts. The venous and arterial flow system 230 may use a diaphragm pump for rapid and efficient air purging. The diaphragm pump may create a vacuum effect within the lines, pulling fluid instead of pushing it throughout the system. This approach prevents water leakage that can be caused by positive pressures. Two similar (or identical) diaphragm pumps generate pulsations in femoral and jugular arteries, replicating real arterial flow patterns. The blood flow of the venous and arterial flow system 230 may be controlled/regulated via pulse-width modulation for precise control and adjustability across different intensity levels (e.g., two, three, four, five, six, seven, eight, or other suitable number of levels). A micro centrifugal liquid pump may control venous flow electronically with voltage changes affecting speed in different flow levels (e.g., two, three, four, five, six, seven, eight, or other suitable number of levels). Check valves ensure proper pressure regulation and liquid flow through the system. The venous and arterial flow system 230 employs separate pumps and valves that enable independent simulation of jugular, femoral, and right arm components, ensuring versatility and accuracy in various medical scenarios. The venous and arterial flow system 230 provides an accurate simulation of blood flow dynamics that can facilitate generating accurate ultrasound images in the various ultrasound compatible inserts of the patient simulator 100.

As shown in FIG. 5, the venous and arterial flow system 230 includes arterial lines 305 and venous lines 310. The arterial lines 305 simulate natural arteries and connect the reservoir(s) 220 to one or more portions and/or inserts of the patient simulator 100 that include simulated arteries. The venous lines 310 simulate natural veins and connect the reservoir(s) 220 to one or more portions and/or inserts of the patient simulator 100 that include simulated veins. Arterial pumps 315 pull fluid (e.g., simulated blood) from the reservoir(s) 220 and pump the fluid through the arterial lines 305. A venous pump 320 pulls fluid (e.g., simulated blood) from the reservoir(s) 220 and pumps the fluid through the venous lines 310. One or more check valves 325 may be utilized as shown to ensure proper pressure regulation and liquid flow through the system, including preventing unwanted backflow. The venous pump 320 may pump the fluid to a manifold 330. The manifold 330 may distribute the fluid to multiple different venous lines 310. In this regard, valves 335 and/or check valves 325 may be utilized to control which of the different venous lines 310 connected to the manifold 330 receive and/or circulate the fluid at any given time. In some aspects, a controller of the venous and arterial flow system 230 may provide signals to the valves 335 to open and/or close the valves 335 to achieve flow to and through the desired venous lines 310.

In the illustrated example, the venous and arterial flow system 230 provides venous and arterial blood flow to the subclavian insert 265, the arm insert 255, and the right and left femoral inserts 260, 262, though the venous and arterial flow system 230 may provide venous and/or arterial blood flow to other inserts and/or portions of the patient simulator 100. After the fluid passes through the insert(s) (e.g., the subclavian insert 265, the arm insert 255, and/or the right and left femoral inserts 260, 262) the fluid goes through check valves 325 and into a return manifold 340. The return manifold 340 is coupled to a return line 345 in communication with the reservoir(s) 220. Accordingly, the fluid that passes through the arterial lines 305 and/or the venous lines 310 may return to the reservoir(s) via the return manifold 340 and the return line 345.

The venous and arterial flow system 230 also includes a purge pump 350. When activated, the purge pump 350 primes the system by removing air from the arterial lines 305 and/or the venous lines 310 and filling the arterial lines 305 and/or the venous lines 310 with fluid from the reservoir(s) 220. The purge pump 350 may be a diaphragm pump. The diaphragm pump may facilitate rapid and efficient air purging by creating a vacuum effect within the arterial lines 305 and/or venous lines 310, pulling fluid instead of pushing it throughout the system. When the purge pump 350 is not activated, the fluid in return line 345 passes through the check valve 325 in parallel with the purge pump 350, as shown in FIG. 5.

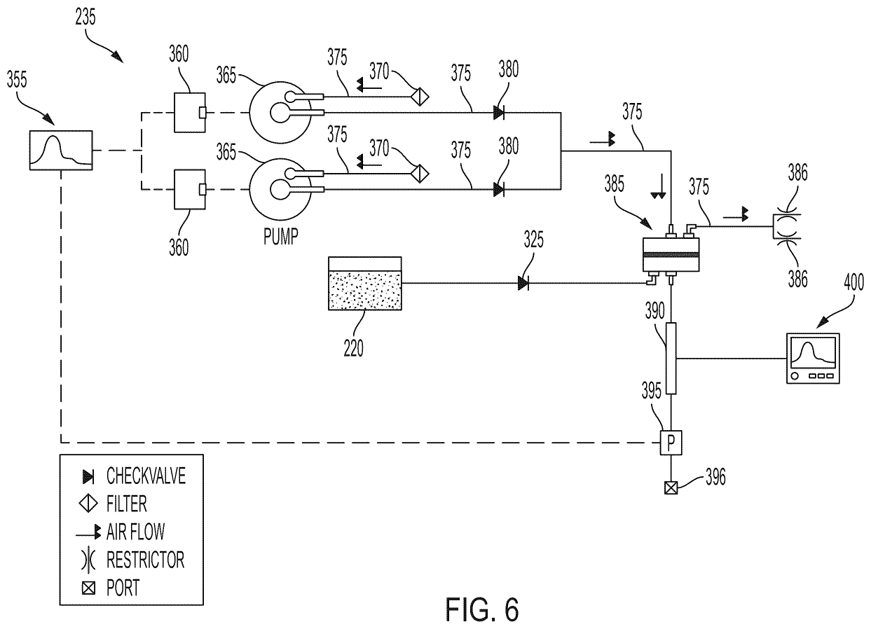

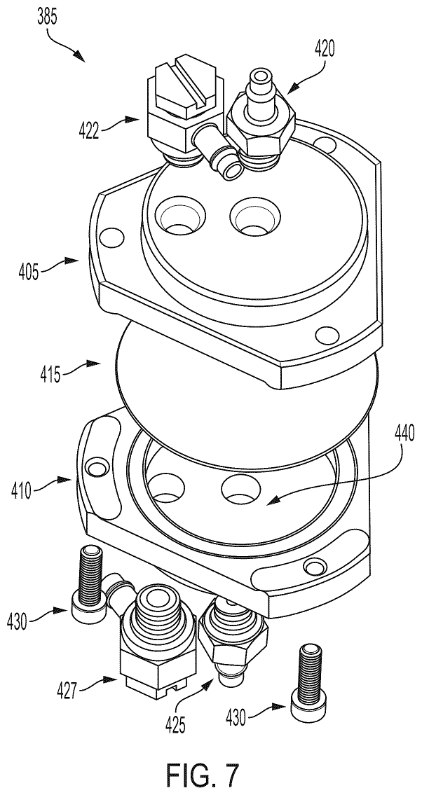

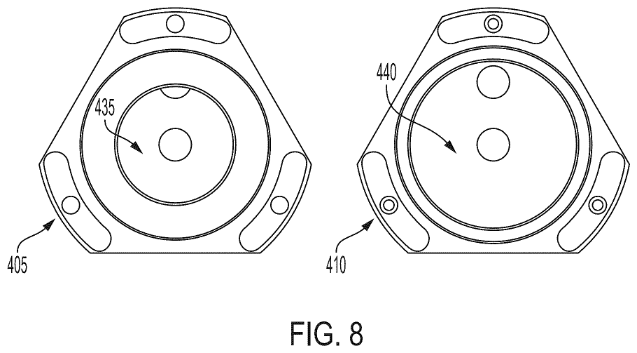

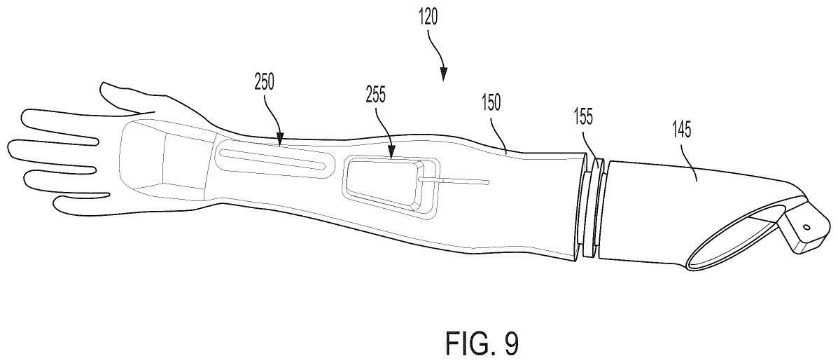

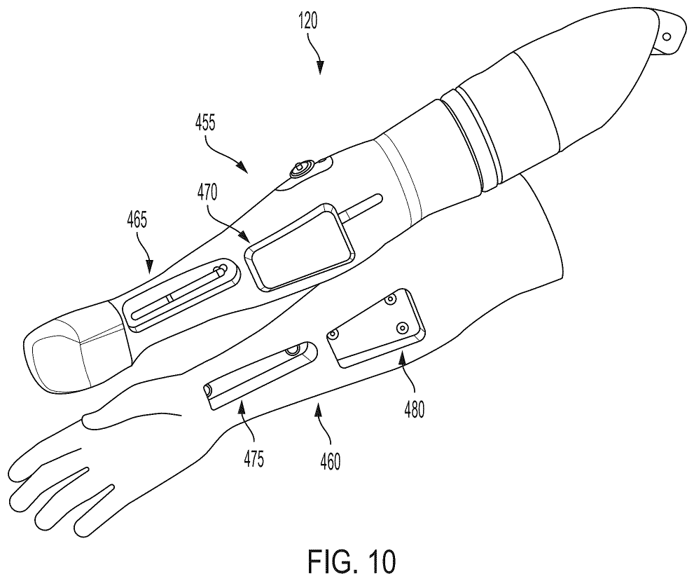

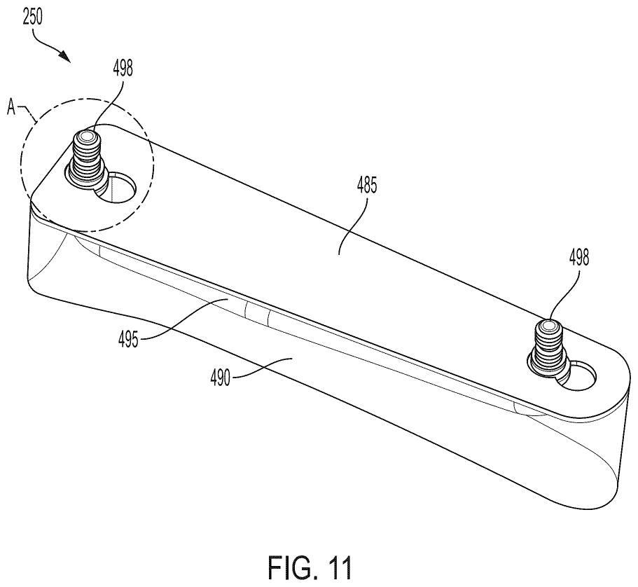

Referring now to FIGS. 6-11, with continuing reference to FIGS. 1-5, the patient simulator 100 includes an invasive blood pressure system 235. In this regard, FIG. 6 is a schematic view of the invasive blood pressure system 235 of the patient simulator 100, according to one or more aspects of the present disclosure. FIG. 7 is an exploded view of a transmitter of the invasive blood pressure system 235, according to one or more aspects of the present disclosure. FIG. 8 is an end view of plates of the transmitter of the invasive blood pressure system 235, according to one or more aspects of the present disclosure. FIG. 9 is a perspective view of the right arm 120 of the patient simulator 100 incorporating aspects of the invasive blood pressure system 235, according to one or more aspects of the present disclosure. FIG. 10 is an exploded view of the right arm 120 of the patient simulator 100, according to one or more aspects of the present disclosure. FIG. 11 is a perspective view of an invasive blood pressure insert of the patient simulator 100, according to one or more aspects of the present disclosure. The invasive blood pressure system 235 simulates blood pressure inside the body during patient monitoring. The invasive blood pressure system 235 may utilize piezoelectric pump(s) controlled by an analog or digital input signal for precise pulse regulation. A transmitter (may also be referred to as a transducer) transmits air pulsations to the simulated blood through a silicone membrane. The transmitter may employ separate chambers, one air chamber and one liquid chamber, divided by a silicone membrane. The liquid chamber may be connected to the reservoir(s) 220 of the patient simulator 100. A pressure sensor positioned in the vein can detect user pressure and can be used to initiate the invasive blood pressure procedure. Check valves of the invasive blood pressure system 235 ensure proper pressure regulation, liquid flow, and system protection. The invasive blood pressure system 235 provides a highly realistic pulse sensation and accurately replicates patient readings on commercially available invasive blood pressure monitoring systems (e.g., blood pressure monitoring system 400 of FIG. 6), as indicated on the associated patient vital signs monitor, which often includes blood pressure, pulse waveform, and heart rate. The invasive blood pressure system 235 provides accurate pressure readings with maximum variations of +/−10 mmHg, typically within +/−5 mmHg, within +/−2 mmHg or less.

As shown in FIG. 6, the invasive blood pressure system 235 includes a microcontroller 355 that provides an input signal (e.g., analog or digital) representative of the desired blood pressure profile, including the associated pulse to one or more pump drivers 360. The pump drivers 360, in turn, control one or more pumps 365 in accordance with the input signal. In some instances, each pump driver 360 may be associated with a corresponding pump 365. In some instances, a single pump driver 360 may be associated with multiple pumps 365. The invasive blood pressure system 235 may include one, two, three, or more pumps 365. In this regard, the pumps 365 are configured to draw air through a filter 370 into a corresponding air line 375. The pumps 365 pressurize the air and transmit the pressurized air along air line 375 towards a check valve 380. The pressurized air from each of the pumps 365 is then combined into a single air line 375 after the check valves 380. The pressurized air travels along air line 375 to a transmitter 385. The transmitter 385 may also be referred to as transducer. In this regard, the transmitter 385 may be configured to transmit the air pulsations from the pumps 365 to simulated blood in a vessel 390 (e.g., vein and/or artery) of the patient simulator. One or more restrictors 386 may allow the pressurized air to release from the air lines 375 and/or the transmitter 385. In some instances, the restrictors 386 may include a small diameter opening (e.g., between about 0.001″ and about 0.01″ in some instances, including 0.005″) that allows pressurized air to slowly release from the air lines 375 over time without compromising the ability of the system to create pulsatile air pressures that are transmitted to the fluid (e.g., simulated blood). In other instances, the invasive blood pressure system 235 may include one or more bleed valves and/or other controllable valves to control the release of air from the air lines 375 and/or the transmitter 385.

A pressure sensor 395 monitors the pressure within the vessel 390 (directly or indirectly). The pressure sensor 395 may be in communication with a port 396. The pressure sensor 395 can provide pressure signals to the microcontroller 355 based on the measured pressure. The microcontroller 355 can compare the pressure signals received from the pressure sensor 395 to the input signal to ensure that the invasive blood pressure system 235 is providing the desired blood pressure profile. If there are discrepancies between the input signal and what is detected by the pressure sensor 395, then the microcontroller 355 can adjust the control signals transmitted to the pump drivers 360 accordingly. In this manner, the pressure sensor 395 can facilitate providing closed-loop monitoring of the blood pressure profile generated by the invasive blood pressure system 235.

Referring more specifically to FIGS. 7 and 8, additional details of an example of the transmitter 385 will be described. As shown in FIG. 7, the transmitter 385 may include a first plate 405, a second plate 410, and a membrane 415 positioned between the first and second plates. The membrane 415 may be a silicone membrane configured to transmit air pulses to a fluid (e.g., simulated blood) in a vessel of the patient simulator 100. A connector 420 may, directly or indirectly, connect the first plate 405 to the air line 375 with the pressurized air from the pumps 365. A connector 422 may, directly or indirectly, connect the first plate 405 to the air line 375 leading to the restrictors 386. A connector 425 may, directly or indirectly, connect the second plate 410 to the vessel 390. A connector 427 may, directly or indirectly, connect the second plate 410 to a venous and/or arterial line coupled to the reservoir(s) 220. Fasteners 430 (e.g., screws, bolts, washers, nuts, threaded openings, clamps, etc.) may be utilized to secure the first plate 405 and the second plate 410 together with the membrane 415 positioned therebetween. In this regard, as best seen in FIG. 8, the first plate 405 may include an air chamber 435 that receives the pressurized air from the pumps 365, while the second plate 410 may include a liquid chamber 440 that receives the fluid from the reservoir(s) 220. In use, the pressurized, pulsatile air from the pumps is received within the air chamber 435 imparting a corresponding force to the membrane 415. The resulting disruption in the membrane 415 causes an associated force to be transmitted to the liquid in the liquid chamber 440 that is in communication with the vessel 390 of the patient simulator 100.

Referring more specifically to FIGS. 9-11, the right arm 120 of the patient simulator 100 may include the invasive blood pressure insert 250 containing the vessel 390. As shown in FIG. 10, the right arm 120 may include a substructure 455 and a skin overlay 460. The substructure 455 may include a recess 465 for the invasive blood pressure insert 250 and a recess 470 for the arm insert 255. Likewise, the skin overlay 460 may include a recess 475 for the invasive blood pressure insert 250 and a recess 480 for the arm insert 255. The invasive blood pressure insert 250 may include a simulated arterial system including a radial artery with the ability, when used with the invasive blood pressure system 235, to perform invasive blood pressure monitoring using standard commercially available invasive blood pressure monitoring systems. In some instances, the invasive blood pressure insert 250 in combination with the invasive blood pressure system 235 simulates arterial pressures between about 30 mmHg and about 200 mmHg and heart rates between about 30 beats per minute and 200 beats per minutes, though other values (both higher and lower) may be used in some instances. The invasive blood pressure insert 250 provides a palpable pulse. As shown in FIG. 11, the invasive blood pressure insert 250 may include a base plate 485, a skin layer 490, a vessel 495 (e.g., vein and/or artery), and connectors 498. The connectors 498 may be configured to connect the invasive blood pressure insert 250 to other venous and/or arterial lines of the invasive blood pressure system 235 and/or the venous and arterial flow system 230, including the reservoir(s) 220.

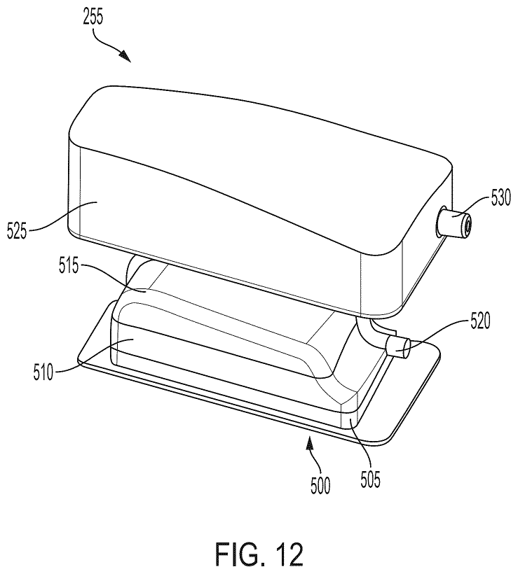

Referring now to FIG. 12, with continuing reference to FIGS. 1-5, the patient simulator 100 includes an arm insert 255. In this regard, FIG. 12 is a perspective view of the arm insert 255 of the patient simulator 100, according to one or more aspects of the present disclosure. The arm insert 255 may be a venous insert for IV placement training, venipuncture practice, and/or blood draw exercises. The arm insert 255 may be a multi-layer surgical insert that includes a skin layer, subcutaneous tissue, muscle, and/or a radial vein. The arm insert 255 provides realistic flashback when a needle bevel enters the vein. As shown in FIG. 12, the arm insert 255 may include a baseplate 500, a bottom skin layer 505, a muscle layer 510, a fat layer 515, a vessel 520 (e.g., vein and/or artery), an upper skin layer 525, and a connector 530. The connector 530 may be configured to connect the arm insert 255 to other venous and/or arterial lines of the venous and arterial flow system 230, including the reservoir(s) 220.

Referring now to FIG. 13, with continuing reference to FIGS. 1-5, the patient simulator 100 includes a left arm 125 providing IV training functionality. In this regard, FIG. 13 is a perspective view of the left arm 125 of the patient simulator 100, according to one or more aspects of the present disclosure. The left arm 125 may include an IV training system 285. The IV training system 285 may include cephalic (antecubital), basilic, radial, ulnar, and/or dorsal hand veins for infusion and blood draw training. The left arm 125 provide realistic tactile feedback and the vein(s) provide flashback once a needle bevel enters the vein. In some aspects, the vein(s) of the left arm 125 may be filled with a fluid (e.g., simulated blood). In some instances, the fluid may be static within the vein(s). In other instances, the left arm 125 and/or the IV training system 285 may include features similar to or the same as those found in the S.M.A.S.H Advanced IV Training Arm available from Gaumard Scientific Company, Inc. In this regard, the left arm 125 may generate arterial pulses at the radial and brachial sites and control arterial blood flow by allowing variable heart rate and pulse strength. The left arm 125 may include interchangeable arterial and venous inserts within the forearm to allow creation of arteriovenous (AV) fistulas and placement of AV grafts. Further, a simulated healed fistula insert provides a platform on which hemodialysis exercises can be performed. An additional multi-layer insert in the bicep area can be used for incision and suture training exercises. In some aspects, the left arm 125 operates independently from the venous and arterial flow system 230.

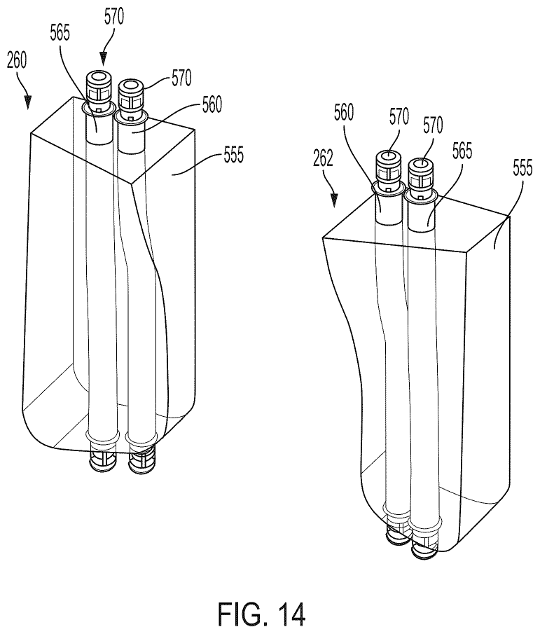

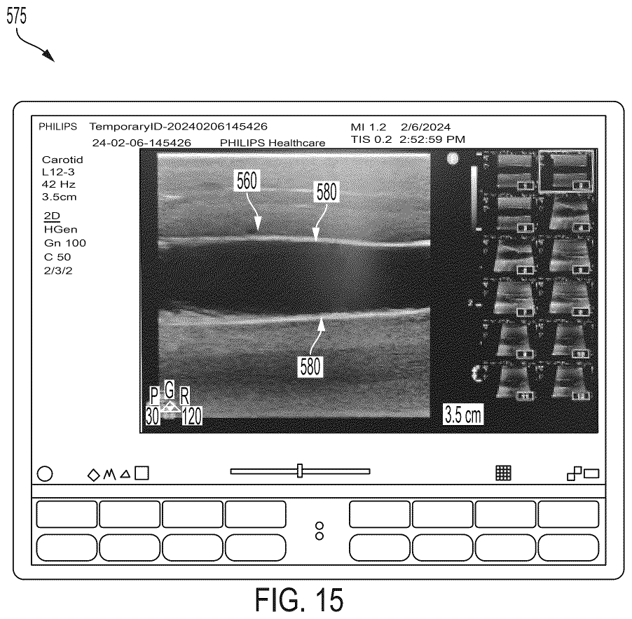

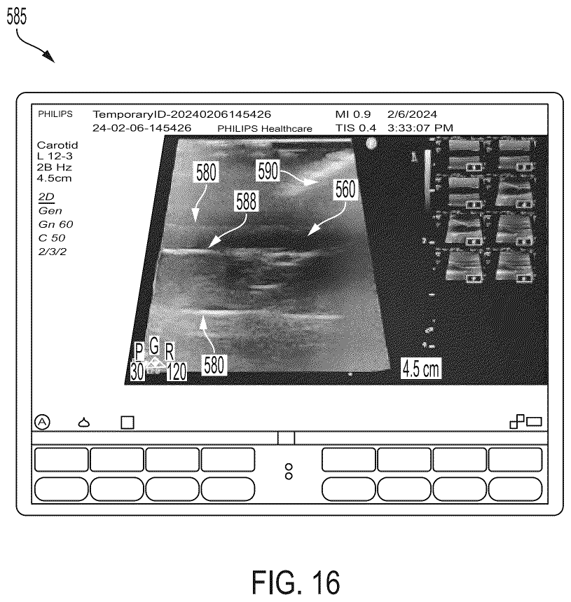

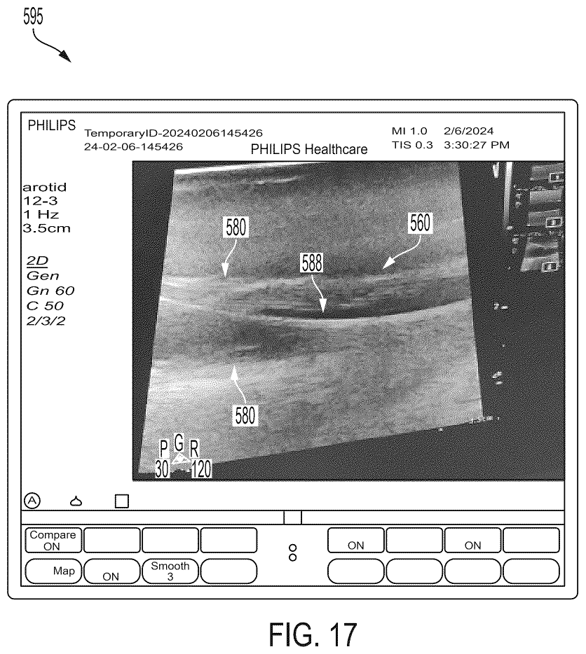

Referring now to FIGS. 14-17, with continuing reference to FIGS. 1-5, the patient simulator 100 includes femoral inserts 260, 262. In this regard, FIG. 14 is a perspective view of the femoral inserts 260, 262 of the patient simulator 100, according to one or more aspects of the present disclosure. FIG. 15 is an ultrasound image of the femoral insert 260 of the patient simulator 100, according to one or more aspects of the present disclosure. FIG. 16 is an ultrasound image showing a guidewire and a needle in use with the femoral insert 260 of the patient simulator 100, according to one or more aspects of the present disclosure. FIG. 17 is an ultrasound image showing a guidewire in use with the femoral insert 260 of the patient simulator 100, according to one or more aspects of the present disclosure. As shown in FIG. 14, each of the femoral inserts 260, 262 includes a skin layer 555, a vein 560, an artery 565, and connectors 570. The connectors 570 may be configured to connect the vein 560 and/or the artery 565 to other venous and/or arterial lines of the venous and arterial flow system 230, including the reservoir(s) 220, the arterial pumps 315, the venous pump 320, etc. The femoral inserts 260, 262 may be utilized for central line placement. In this regard, the femoral inserts 260, 262 may be ultrasound compatible to allow ultrasound-guided central line placement. The vein 560 and the artery 565 of the femoral inserts 260, 262 are distinctly visible and easy to differentiate under ultrasound, as well as palpitation. In some aspects, the vein 560 and/or the artery 565 are formed of silicone and include an additive to increase the contrast of the vessel wall under ultrasound. For example, in some instances a Ure-Fil™ filler from Smooth-On may be utilized. In this regard, in some aspects the materials used for the ultrasound compatible inserts of the present disclosure, as well as other inserts of the present disclosure, are similar to or the same as those described in U.S. Pat. No. 8,678,831, filed Feb. 18, 2011 and titled “ULTRASOUND PHANTOM MODELS, MATERIALS, AND METHODS”, U.S. Pat. No. 8,608,483, filed Feb. 18, 2011 and titled “BREAST TISSUE MODELS, MATERIALS, AND METHODS”, and U.S. Pat. No. 10,937,338, filed Sep. 7, 2018 and titled “SURGICAL SIMULATION MODELS, MATERIALS, AND METHODS,” each which is hereby incorporated by reference in its entirety. Also, the vein 560 may be compressible and pulsations of the artery 565 may be visible. The femoral inserts 260, 262 are suitable for multiple uses even after a scalpel and dilator have been used.

Referring now to FIGS. 15-17, shown therein are examples of the femoral inserts 260, 262 being imaged using a commercially available ultrasound imaging system. FIG. 15 provides an image 575 showing the vein 560. In particular, the vessel walls 580 are clearly visible and distinguishable from the surrounding tissue. FIG. 16 provides an image 585 showing the vein 560 and associated vessel walls 580 along with a guidewire 588 positioned within a lumen of the vein 560. A needle 590 is also visible. In this regard, the needle 590 and/or the guidewire 588 (or a catheter) may be used in a variety of procedures under ultrasound guidance, including a central line placement (including femoral, as shown, as well as jugular (e.g., using the subclavian insert 265). FIG. 17 provides an image 595 showing the vein 560 and associated vessel walls 580 along with a guidewire 588 positioned within a lumen of the vein 560. While FIGS. 15-17 are provided in the context of the femoral inserts 260, 262, it is understood that the same or similar ultrasound functionality is provided with at least the subclavian insert 265 and the paracentesis insert 270 of the present disclosure.

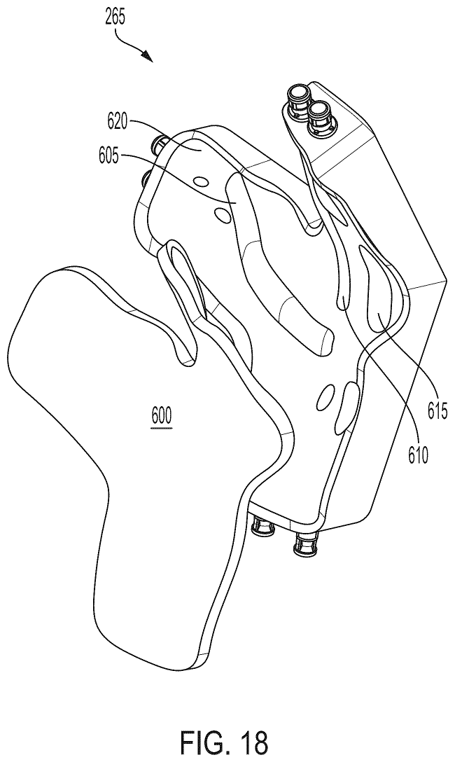

Referring now to FIG. 18, with continuing reference to FIGS. 1-5, the patient simulator 100 includes a subclavian insert 265. In this regard, FIG. 18 is a partially exploded view of the subclavian insert 265 of the patient simulator 100, according to one or more aspects of the present disclosure. The subclavian insert 265 may be a unilateral insert on the right side of the neck 110 and/or torso 115 that provides subclavian (infraclavicular and supraclavicular) and IJ access. The subclavian insert 265 includes a skin layer 600, a subclavian rib/clavicle 605, a vein 610, an artery 615, and base material 620. The vein 610 and the artery 615 may be similar to the veins and arteries of the femoral inserts 260, 262 described above. In other instances, the vein 610 and the artery 615 may be defined by lumens or openings within base material 620. For example, in some instances the base material 620 may include a Ure-Fil™ filler to increase contrast relative to a fluid within the lumens/openings under ultrasound imaging. The subclavian insert 265 may be utilized for central line placement. In this regard, the subclavian insert 265 may be ultrasound compatible to allow ultrasound-guided central line placement. In this regard, the vein 610 and the artery 615 of the subclavian insert 265 are distinctly visible and easy to differentiate under ultrasound. Also, the vein 610 may be compressible and pulsations of the artery 615 may be visible. Further, the subclavian rib/clavicle 605 of the subclavian insert 265 can be identified under ultrasound. The subclavian insert 265 is suitable for multiple uses even after a scalpel and dilator have been used.

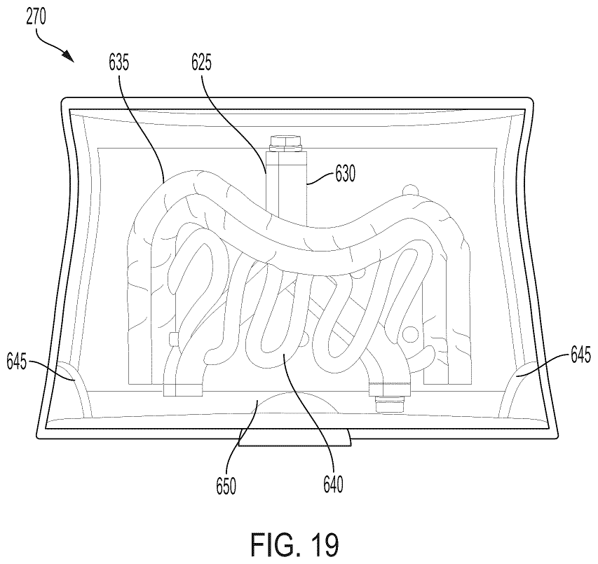

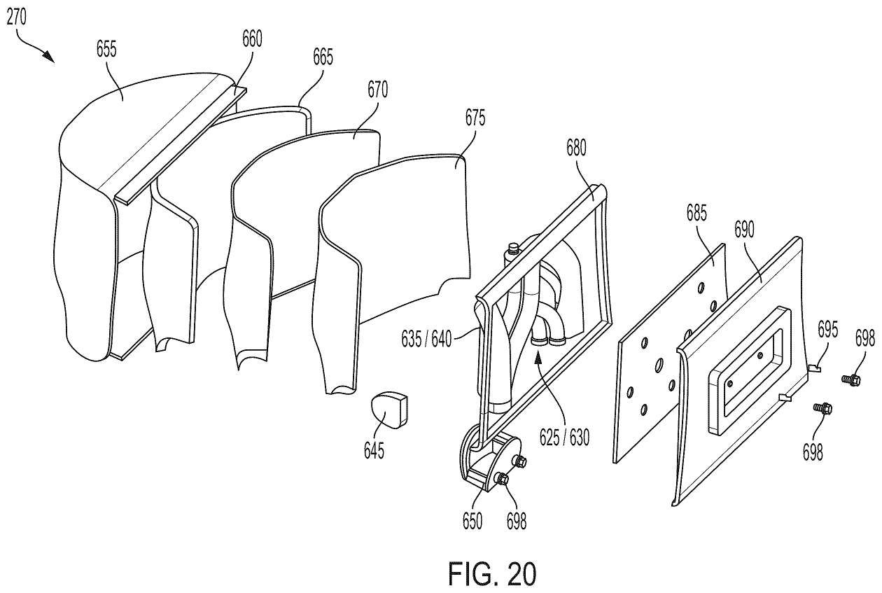

Referring now to FIGS. 19-20, with continuing reference to FIGS. 1-5, the patient simulator 100 includes a paracentesis insert 270. In this regard, FIG. 19 is a front view of the paracentesis insert 270 of the patient simulator 100, according to one or more aspects of the present disclosure. FIG. 20 is an exploded view of the paracentesis insert 270, according to one or more aspects of the present disclosure. The paracentesis insert 270 may be an ultrasound compatible abdominal insert. The paracentesis insert 270 can be filled with air, simulated blood, or any fluid of choice for paracentesis exercises. The paracentesis insert 270 may include a skin layer, fascia, muscle, a peritoneal cavity, small and large intestines, a bladder, an abdominal aorta with bifurcation, and/or an inferior vena cava with bifurcation. The paracentesis insert 270 can be punctured and re-used multiple times.

As shown in FIG. 19, the paracentesis insert 270 may include an inferior vena cava 625, including a bifurcation. The paracentesis insert 270 may also include an abdominal aorta 630, including a bifurcation. The paracentesis insert 270 may also include a large intestine 635, a small intestine 640, and anterior superior iliac spines 645 associated with each hip. The paracentesis insert 270 may also include a bladder 650. The paracentesis insert 270 defines a cavity around the other structures that can be filled with air, simulated blood, or any fluid of choice. FIG. 20, shows an exploded view of the paracentesis insert 270 including an upper skin layer 655, a skin support 660, an adipose tissue layer 665, a fascia layer 670, a muscle layer 675, a support skin 680, a structural cover 685, a lower skin layer 690, tubing 695, and connectors 698. The connectors 698 and/or the tubing 695 may be configured to connect the inferior vena cava 625 and/or the abdominal aorta 630 to other venous and/or arterial lines of the venous and arterial flow system 230, including the reservoir(s) 220, the arterial pumps 315, the venous pump 320, etc. In other instances, the paracentesis insert 270 may be self-contained in terms of fluid and/or fluid flow.

The ultrasound-guided procedure inserts described in the context of FIGS. 14-20 are removable/replaceable. In some aspects, an ultrasound-guided procedure insert comprises: a simulated skin layer; a body coupled to the simulated skin layer; and at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system. The at least one simulated vessel may comprise a simulated vein, a simulated artery, or a simulated vein and a simulated artery. The at least one simulated vessel may further comprise a bifurcation.

The simulated skin layer, the body, and the at least one simulated vessel may be sized and shaped to simulate a femoral access site. The simulated skin layer, the body, and the at least one simulated vessel may be sized and shaped to simulate a subclavian access site. The insert may further comprise a simulated clavicle positioned at least partially within the body. The simulated skin layer, the body, and the at least one simulated vessel may be sized and shaped to simulate a paracentesis access site. The insert may further comprise a simulated large intestine coupled to the body; and a simulated small intestine coupled to the body. The at least one simulated vessel may include an abdominal aorta and an inferior vena cava. The abdominal aorta may include a bifurcation. The inferior vena cava may include a bifurcation. The insert may further comprise a simulated bladder coupled to the body.

In some aspects, the ultrasound-guided procedure inserts may be integrated into a patient simulator instead of being provided as a removable/replaceable insert. In some aspects, a patient simulator, comprises: a simulated body portion, the simulated body portion including an ultrasound-guided procedure site, the ultrasound-guided procedure site comprising: a simulated skin layer; a body coupled to the simulated skin layer; and at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system.

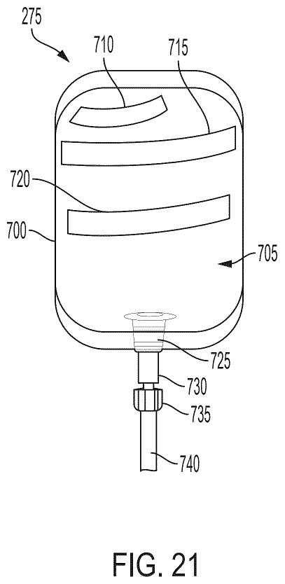

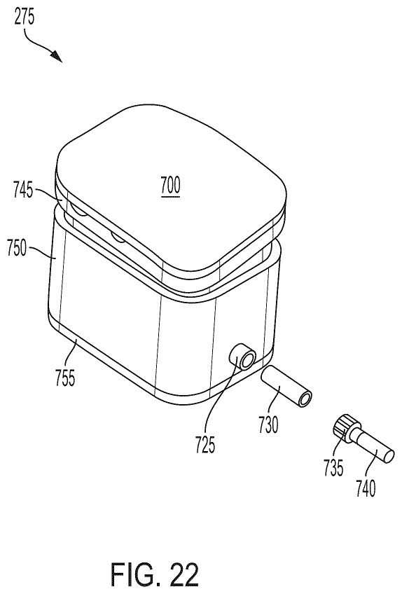

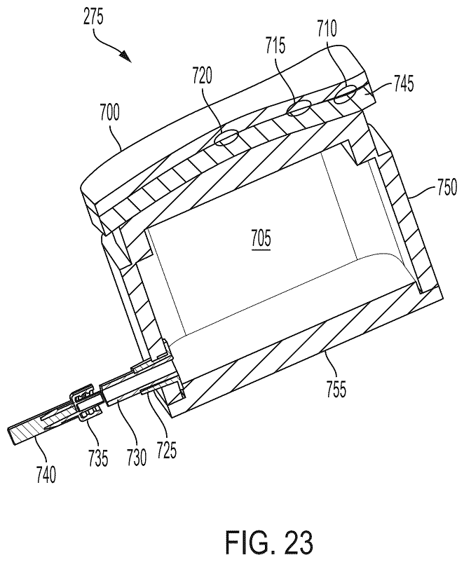

Referring now to FIGS. 21-23, with continuing reference to FIGS. 1-5, the patient simulator 100 includes a pneumothorax insert 275. In this regard, FIG. 21 is a front view of the pneumothorax insert 275 of the patient simulator 100, according to one or more aspects of the present disclosure. FIG. 22 is a perspective view of the pneumothorax insert 275 of FIG. 21, according to one or more aspects of the present disclosure. FIG. 23 is a perspective cross-sectional view of the pneumothorax insert 275 of FIGS. 21-22, according to one or more aspects of the present disclosure. In some aspects, the pneumothorax insert 275 may be a unilateral insert on the left side of torso 115 of the patient simulator 100 that allows access at the second intercostal space. The pneumothorax insert 275 can be used to simulate a tension pneumothorax and includes palpable landmarks to find the second intercostal space for needle insertion. A chamber of the pneumothorax insert 275 can be pressurized such that an audible hiss is heard after proper needle insertion.

As shown in FIGS. 21-23, the pneumothorax insert 275 includes a skin layer 700, a chamber 705, a first rib 710, a second rib 715, and a third rib 720. A flange 725, a tubing 730, a connector 735 (e.g., luer lock connector or other suitable connector), and a flexible tubing 740 extend from the chamber 705, as best seen in FIG. 23. In this regard, the chamber 705 of the pneumothorax insert 275 can be pressurized through the introduction of air through the flexible tubing 740 and into the chamber 705. In some instances, the flexible tubing is coupled to a port on a side of the patient simulator 100. A hand pump (e.g., squeeze bulb pump or otherwise) may be coupled to the port and utilized to pressurize the chamber 705. In other instances, the flexible tubing 740 may be connected to an electronic pump (either external or part of the patient simulator) that is utilized to selectively pressurize the chamber 705. When a user finds the second intercostal space and properly inserts a needle through the skin layer 700 and into the chamber 705 an audible hiss consistent with a natural pneumothorax procedure is produced. As shown in FIG. 23, the of the pneumothorax insert 275 may also include an upper plate 745, a body 750, and a base plate 755.

Aspects of the present disclosure include:

1. An ultrasound-guided procedure insert for a patient simulator, the insert comprising:
a simulated skin layer;
a body coupled to the simulated skin layer; and
at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system.

2. The insert of aspect 1, wherein the at least one simulated vessel comprises a simulated vein.

3. The insert of aspect 1 or 2, wherein the at least one simulated vessel comprises a simulated artery.

4. The insert of any of aspects 1-3, wherein the at least one simulated vessel comprises a simulated vein and a simulated artery.

5. The insert of any of aspects 1-4, wherein the at least one simulated vessel comprises a bifurcation.

6. The insert of any of aspects 1-5, wherein the simulated skin layer, the body, and the at least one simulated vessel are sized and shaped to simulate a femoral access site.

7. The insert of any of aspects 1-5, wherein the simulated skin layer, the body, and the at least one simulated vessel are sized and shaped to simulate a subclavian access site.

8. The insert of aspect 7, further comprising a simulated clavicle positioned at least partially within the body.

9. The insert of any of aspects 1-5, wherein the simulated skin layer, the body, and the at least one simulated vessel are sized and shaped to simulate a paracentesis access site.

10. The insert of aspect 9, further comprising:
a simulated large intestine coupled to the body; and
a simulated small intestine coupled to the body.

11. The insert of any of aspects 9-10, wherein the at least one simulated vessel includes:
an abdominal aorta; and
an inferior vena cava.

12. The insert of aspect 11, wherein the abdominal aorta includes a bifurcation.

13. The insert of any of aspects 11-12, wherein the inferior vena cava includes a bifurcation.

14. The insert of any of aspects 9-13, further comprising:
a simulated bladder coupled to the body.

15. A patient simulator, comprising:
a simulated body portion, the simulated body portion including an ultrasound-guided procedure site, the ultrasound-guided procedure site comprising:
   a simulated skin layer;
   a body coupled to the simulated skin layer; and
   at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system.

16. A device, system, or method according to one or more aspects of the present disclosure.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

What is claimed is:

1. An ultrasound-guided procedure insert for a patient simulator, the insert comprising:
a simulated skin layer;
a body coupled to the simulated skin layer; and
at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system.

2. The insert of claim 1, wherein the at least one simulated vessel comprises a simulated vein.

3. The insert of claim 1, wherein the at least one simulated vessel comprises a simulated artery.

4. The insert of claim 1, wherein the at least one simulated vessel comprises a simulated vein and a simulated artery.

5. The insert of claim 1, wherein the at least one simulated vessel comprises a bifurcation.

6. The insert of claim 1, wherein the simulated skin layer, the body, and the at least one simulated vessel are sized and shaped to simulate a femoral access site.

7. The insert of claim 1, wherein the simulated skin layer, the body, and the at least one simulated vessel are sized and shaped to simulate a subclavian access site.

8. The insert of claim 7, further comprising a simulated clavicle positioned at least partially within the body.

9. The insert of claim 1, wherein the simulated skin layer, the body, and the at least one simulated vessel are sized and shaped to simulate a paracentesis access site.

10. The insert of claim 9, further comprising:
a simulated large intestine coupled to the body; and
a simulated small intestine coupled to the body.

11. The insert of claim 10, wherein the at least one simulated vessel includes:
an abdominal aorta; and
an inferior vena cava.

12. The insert of claim 11, wherein the abdominal aorta includes a bifurcation.

13. The insert of claim 11, wherein the inferior vena cava includes a bifurcation.

14. The insert of claim 10, further comprising:
a simulated bladder coupled to the body.

15. A patient simulator, comprising:
a simulated body portion, the simulated body portion including an ultrasound-guided procedure site, the ultrasound-guided procedure site comprising:
a simulated skin layer;
a body coupled to the simulated skin layer; and
at least one simulated vessel positioned at least partially within the body, wherein the at least one simulated vessel is configured to be coupled to a system to control a flow of simulated blood through the simulated vessel, wherein the at least one simulated vessel is configured to be imaged using a commercially available ultrasound imaging system.
